(19) United States
(12) Patent Application Publication
(10) Pub. No.: US 2003/0089661 A1
(43) Pub. Date: May 15, 2003

(54) Treatment of polyaluminium compounds

(75) Inventor: Felix Hulten, Vastra Frolunda (SE)

Correspondence Address: Law Offices of David J. Serbin, Unit 2 - First Floor, 1423 Powhatan Street, Alexandria, VA, 22314, US

(73) Assignee: AKZO NOBEL N.V.

(21) Appl. No.: 10/282,130

(22) Filed: Oct. 29, 2002

Related U.S. Application Data
(60) Provisional application No. 60/330,850, filed on Nov. 1, 2001.

(51) Int. Cl. B01D 61/00

(52) U.S. Cl. 210/651; 210/639; 210/650

(57) ABSTRACT

The invention relates to a method for treating an aqueous polyaluminium compound solution comprising feeding a feed solution containing at least one polyaluminium compound to an ultrafiltration unit, separating a retentate fraction having a higher aluminium content than the feed solution from a permeate fraction having a lower content of aluminium than the feed solution. The invention also relates to an aqueous polyaluminium compound solution obtainable by the method and the use thereof as a flocculant or antiperspirant and/or treating water.

The present invention relates to a method for treating aqueous solutions containing polyaluminium compounds. The invention also relates to polyaluminium compound solutions obtained by the method, and to a method of treating water containing flocs comprising adding the polyaluminium compound solutions to water.

### BACKGROUND OF THE INVENTION

The use of polyaluminium compounds as flocculants is well known in the arts of water treatment and paper production. Various methods have been developed to produce polyaluminium solutions in an efficient way, especially solutions containing polyaluminium compounds with a high aluminium content. Such methods have involved e.g. chemical reactions of hydrochloric acid and aluminium compounds such as aluminium chloride, aluminium sulphate etc under pressure. This is described in e.g. EP 0884278 A1 in which a part of the production process of polyaluminium hydroxide is performed above atmospheric pressure. Metallic aluminium has also been used to increase the aluminium content of the produced polyaluminium compounds. However, these methods have not shown to be profitable due to the high raw material and energy costs involved.

It would be desirable to produce polyaluminium compound solutions having a high aluminium content in alternative energy-saving ways.

It would be desirable to provide a new efficient method for producing polyaluminium compounds having a high aluminium content without the drawbacks of the prior art. It would be particularly desirable to produce polyaluminium compound solutions in which the basicity of the compound can be varied in a wider range. The basicity (expressed in percent) corresponds to the number of hydroxide groups multiplied by 100 divided with 3 times the number of aluminium atoms. In many instances, a high basicity is known to provide a stable dispersion of the polyaluminium compounds, but in some applications, a low basicity may be desired. It has also been desired in the art to provide polyaluminium compounds having a low content of contaminants. It is an object of the present invention to solve these problems.

### THE INVENTION

The present invention relates to a method for treating an aqueous polyaluminium compound solution comprising feeding a feed solution containing at least one polyaluminium compound to an ultrafiltration unit, separating a retentate fraction having a higher aluminium content than the feed solution from a permeate fraction having a lower aluminium content than the feed solution.

It has been found that polyaluminium compounds having an increased content of aluminium can be obtained in a retentate fraction by means of ultrafiltration according to the inventive method. It has also been found that the method simultaneously can provide polyaluminium compounds with a more flexible range of basicity. It is thus possible to produce polyaluminium compound solutions having a wider range of basicity for polyaluminium compounds having different aluminium contents. In some cases, a high basicity can provide a more stable system in which the polyaluminium compound flocculant can work more efficiently. This is the case in the flocculation of sludges of clay. Flocculants with low basicity may be desired e.g. in the flocculation of phosphate in water purification. Also in water systems having a high alkalinity, the basicity of a polyaluminium compound added to the system suitably is fairly low.

By the term “polyaluminium compound” is meant any polyaluminium compound based on cationic oligomer and/or polymer aluminium ions, such as polyaluminium chloride, polyaluminium sulphate, polyaluminium silicate sulphate (PASS), polyaluminium silicate chloride, polyaluminium nitrate, polyaluminium bromide, and modifications and/or derivatives and/or mixtures thereof. Such compounds may be obtained e.g. by the methods described in EP884 278, WO99/35090, U.S. Pat. No. 5,149,400, and EP 181 847, which hereby are incorporated by reference. Preferably, polyaluminium chloride and derivatives thereof are used in the method described herein.

By the term “ratio” as used herein is meant the mole ratio of hydroxide groups to aluminium (mole [OH]/mole [Al]).

The term “treat” as used herein preferably means “concentrate” the aluminium content of a feed solution fed to an ultrafiltration unit.

The ultrafiltration unit comprises at least one membrane which is suitably made of polyamide, polyacrylnitride, cellulose acetate, PVDF (polyvinylidene fluoride), polysulphone, polyethersulphone or modified polyethersulphone or a combination thereof. The membranes may be arranged either in series or in parallel. The membranes in an ultrafiltration unit may also be selected from membranes made of different materials. However, any membrane resistant to the prevailing conditions during the ultrafiltration process may be used, suitably such membranes being stable at temperatures up to about 80° C., and resisting pressures suitably up to about 80 bar. The cutoff of the membrane suitably ranges from about 800 to about 200000, preferably from about 800 to about 20000, even more preferably from about 1000 to about 15000, and most preferably from about 3000 to about 11000 Dalton.

According to one embodiment, the obtained retentate fraction is at least partly recirculated to the feed solution to be repeatedly passed through the ultrafiltration unit. The recirculation is carried out to obtain a higher aluminium content in the retentate fraction. When a desired aluminium content in the retentate fraction has been obtained, the retentate fraction can be collected as a final product ready for use or further refining.

Suitably, the aluminium content in the feed solution is from about 1 to about 15, preferably from about 4 to about 13, more preferably from about 5 to about 9, and most preferably from about 5 to about 6 wt %.

According to one preferred embodiment, the retentate is recirculated to the feed solution until the aluminium content is at least about 5, preferably at least about 10, and most preferably at least about 15 wt % higher in the retentate fraction than in the feed solution.

The ratio of the feed solution suitably is from about 0.3 to about 2.5, preferably from about 0.5 to about 2. The temperature of the feed solution suitably is from about −30 to about 90, preferably from about 10 to about 30° C.

The pressure over the ultrafiltration unit suitably is from about 2 to about 80, preferably from about 4 to about 40, and most preferably from about 6 to about 20 bar.

The suitable area of the membrane depends on the product treated and should be selected accordingly. The operation time of the ultrafiltration depends on several parameters such as the membrane area, feed solution, the desired aluminium content in the product etc.

During the operation of the ultrafiltration unit, the membranes may become fouled with particles from the polyaluminium feed solution. Such fouling may be removed by conventional measures, e.g. by cleaning the membranes with Ultrasil™ available from Henkel, suitably in a concentration of from about 0.1 to about 0.3 wt %.

The invention also relates to an aqueous polyaluminium compound solution obtained by the method described herein.

The invention also relates to a method of treating water containing flocs comprising adding a polyaluminium compound solution as defined herein to the water.

The obtained polyaluminium compound solutions, i.e. both the retentate fraction and the permeate fraction may be used as a flocculant in water treatment, paper making and the like. The products obtained may also be used as antiperspirants. The permeate fraction may also be further refined by conventional methods including adding the permeate to an acid, preferably hydrochloric acid, and aluminium hydroxide to prepare a polyaluminium compound with a higher aluminium content.

The invention being thus described, it will be obvious that the same may be varied in many ways. Such variations are not to be regarded as a departure from the gist and scope of the present invention, and all such modifications as would be obvious to one skilled in the art are intended to be included within the scope of the claims. The following examples will further illustrate how the described invention may be performed without limiting the scope of it. If not otherwise stated, all contents and percentages as described herein refer to weight percent.

### EXAMPLE 1

A feed solution of a basic polyaluminium chloride product (Ekoflock™ 90 available from Eka Chemicals AB) containing 9.04 wt % aluminium and 4.48 mol/kg hydroxide ions was fed from a feed tank at room temperature by means of a high pressure pump to a BRO/BUF pilot ultrafiltration unit (available from PCI Membrane Systems Ltd). The unit was equipped with a Single-tube Tester containing six membrane tubes (ES404™) made of polyethersulfone having a cutoff of 4000 Dalton. The diameter was 12.5 mm. The tubes were connected in series which yielded a total effective membrane area of 0.28 m². The membranes were made of polyethersulphone, modified polyethersulphone, and polyamide film. The pressure over the ultrafiltration unit was 15 bar and the cross-flow was 1800 litre/hour equalling a flux of 1 I/m²h. The permeate was continually collected while the retentate was recirculated to the feed tank. The ultrafiltration was interrupted after 6 hours. Samples of retentate and permeate fractions were taken and analysed after 3, 5, and 6 hours.

### EXAMPLE 2

A feed solution of a basic polyaluminium chloride product (Ekoflock™ 91 available from Eka Chemicals AB) containing 9.28 wt % aluminium, 4.56 mole/kg hydroxide ions was fed with a cross flow of 1800 litre/hour equalling a flux of 1.2 I/m²h. The further parameters were the same as of example 1. Samples (1-3) of retentate and permeate fractions were taken and analysed after 1, 2, and 3 hours. The results of examples 1-2 are presented in table 1 below.

TABLE 1

| | Al (wt %) | OH (mol/kg) | Ratio |
|---|---|---|---|
| Ekoflock 90 | 9.04 | 4.48 | 1.34 |
| (Feed solution) | | | |
| Retentate 1 | 9.18 | 4.49 | 1.32 |
| Retentate 2 | 9.35 | 4.76 | 1.37 |
| Retentate 3 | 9.39 | 4.77 | 1.37 |
| Permeate 1 | 7.73 | 2.06 | 0.72 |
| Permeate 2 | 7.98 | 2.30 | 0.78 |
| Permeate 3 | 7.81 | 1.97 | 0.68 |
| Ekoflock 91 | 9.28 | 4.56 | 1.33 |
| (Feed solution) | | | |
| Retentate 1 | 9.34 | 4.52 | 1.31 |
| Retentate 2 | 9.32 | 4.56 | 1.32 |
| Retentate 3 | 9.34 | 4.64 | 1.34 |
| Permeate 1 | 7.53 | 2.33 | 0.84 |
| Permeate 2 | 7.64 | 1.7 | 0.60 |
| Permeate 3 | 7.7 | 1.79 | 0.63 |

As can be seen from table 1, an increased concentration of aluminium and the ratio (and thus the basicity) was obtained in the retentate by treating the products Ekoflock™ 90, Ekoflock™ 91 that were used as feed solutions.

### EXAMPLE 3

A feed stream of another basic polyaluminium chloride product containing 4.85 wt % aluminium, 3.63 mol/kg hydroxide ions was fed with a flux of 4.3 l/m²h. The further parameters were the same as of example 1. Samples (1-6) of retentate and permeate were taken and analysed after 10, 20, 30, 40, 50, and 60 minutes. The treatment was interrupted after 1 hour.

TABLE 2

| | Al (wt %) | OH (mol/kg) | Ratio |
|---|---|---|---|
| Feed solution | 4.85 | 3.63 | 2.02 |
| Retentate 1 | 5.2 | 3.83 | 1.99 |
| Retentate 2 | 5.4 | 3.92 | 1.96 |
| Retentate 3 | 5.48 | 4.5 | 2.22 |
| Retentate 4 | 5.95 | 4.92 | 2.23 |
| Retentate 5 | 6.47 | 5.36 | 2.24 |
| Retentate 6 | 7.06 | 5.91 | 2.26 |
| Permeate 1 | 2.03 | 0.91 | 1.21 |
| Permeate 2 | 1.95 | 0.86 | 1.19 |
| Permeate 3 | 2.07 | 0.87 | 1.13 |
| Permeate 4 | 2.12 | 0.96 | 1.22 |
| Permeate 5 | 2.05 | 1 | 1.32 |
| Permeate 6 | 2.52 | 1.18 | 1.26 |

As can be seen, an increase in aluminium and hydroxide content is obtained in the retentate fraction compared to the feed solution. This example also shows that the aluminium content and the ratio (and thus the basicity) are increased in the retentate compared to the feed solution.

1. A method for treating an aqueous polyaluminium compound solution comprising feeding a feed solution containing at least one polyaluminium compound to an ultrafiltration unit, separating a retentate fraction, said retentate fraction having a higher aluminium content than the feed solution, from a permeate fraction having a lower aluminium content than the feed solution.

2. A method according to claim 1, wherein the feed solution is a polyaluminium chloride solution.

3. A method according to claim 1, wherein the feed solution has an aluminium content from about 1 to about 15 wt %.

4. A method according to claim 1, wherein the feed solution has a mole ratio of hydroxide groups to aluminium from about 0.3 to about 2.5.

5. A method according to claim 1, wherein the ultrafiltration unit comprises at least one membrane having a cutoff from about 1000 to about 15000 Dalton.

6. A method according to claim 1, wherein the membrane material is selected from the group consisting of polyamide, polyacrylnitride, cellulose acetate, PVDF (polyvinylidene fluoride), polysulphone, polyethersulphone or modified polyethersulphone, or a combination thereof.

7. A method according to claim 1, wherein the retentate fraction is recirculated at least partly to the feed solution and the method is continued until the aluminium content is from about 5 wt % higher in the retentate fraction than in the feed solution.

8. An aqueous polyaluminium compound solution obtained by treating an aqueous polyaluminium compound solution comprising feeding a feed solution containing at least one polyaluminium compound to an ultrafiltration unit, separating a retentate fraction, said retentate fraction having a higher aluminium content than the feed solution, from a permeate fraction having a lower aluminium content than the feed solution.

9. Method of treating water containing flocs comprising adding a polyaluminium compound solution according to claim 8 to the water.
